(19) United States
(12) Patent Application Publication
(10) Pub. No.: US 2004/0190577 A1
(43) Pub. Date: Sep. 30, 2004

(54) Fast linear motor for wavelength variation for lithography lasers

(76) Inventors: Hans-Stephan Albrecht, Goettingen (DE); Thomas Schmidt, Goettingen (DE); Kay Zimmermann, Bovenden Lenglern (DE); Konstantin Aab, Kassel (DE)

Correspondence Address: STALLMAN & POLLOCK LLP, SUITE 2200, 353 SACRAMENTO STREET, SAN FRANCISCO, CA, 94111, US

(21) Appl. No.: 10/775,493

(22) Filed: Feb. 10, 2004

Related U.S. Application Data
(60) Provisional application No. 60/450,527, filed on Feb. 27, 2003.

(51) Int. Cl. H01S 3/13; H01S 3/22; H01S 3/223

(52) U.S. Cl. 372/55; 372/32

(57) ABSTRACT

Fast wavelength stabilization can be obtained for a gas discharge laser, such as an excimer or molecular fluorine laser, using a fast wavelength correction unit. A fast wavelength correction unit can include a fast, precise motor driver unit, such as a linear or rotary voice coil motor, a piezo-ceramic motor, or a piezo motor driver unit. These motors can be used to rotate a tuning element, for example, in order to provide for precise and fast wavelength stabilization. The wavelength correction unit can be fully contained within an optical module, without the need for seals, bellows, or feedthroughs as in existing drive systems. Various arrangements and embodiments are described which can be appropriate for differing applications and/or systems.

### CLAIM OF PRIORITY

This application claims priority to U.S. Provisional Patent Application No. 60/450,527, entitled “FAST LINEAR MOTION FOR WAVELENGTH VARIATION FOR LITHOGRAHY LASERS,” to Hans-Stephan Albrecht et al., filed Feb. 27, 2003, which is hereby incorporated herein by reference.

### TECHINCAL FIELD OF THE INVENTION

The present invention relates to techniques for stabilizing the wavelength of a gas discharge laser, such as an excimer or molecular fluorine laser.

### BACKGROUND

Excimer lasers and molecular fluorine lasers emitting pulsed UV-radiation are becoming increasingly important instruments in specialized material processing. KrF-excimer lasers emitting around 248 nm, ArF-excimer lasers emitting around 193 nm, and F₂-lasers are currently the light sources of choice for photolithographic processing of integrated circuits. It is often desired when using photolithography to produce integrated circuits that these laser systems can emit a narrow spectral band around a very precisely determined and finely adjustable wavelength. It is further desirable to have techniques for reducing bandwidths to less than 100 pm for semi-narrow band lasers, to less than 1 pm for narrow band lasers, and to less than 0.2 pm for very narrow band lasers, as well as techniques for tuning and controlling central wavelengths of emission. In order to precisely tune the line-narrowed output of an excimer or molecular fluorine laser system to a desired wavelength, a portion of the laser beam can be directed through a wavelength measurement system (WMS), which can include the use of a monitor etalon or grating spectrometer. A WMS can be calibrated to an absolute wavelength reference, such as by directing a portion of the laser beam to an opto-galvanic cell or absorption lamp, or by comparison with a reference laser line or lamp line. Once the dispersion of the WMS is known, or the free spectral range of the monitor etalon is known, an optics control module can tune the optics of the laser resonator to adjust the wavelength to a desired value. Details about the wave-length measurement system are described in U.S. patent application Ser. No. 09/903,425 which is assigned to the same assignee as the present application and hereby incorporated herein by reference.

Fast wavelength correction units can be used, which include a piezoelectric drive with a fast wavelength measurement system and a fast feedback response time. Techniques exist for tuning the laser wavelength using a tuning mirror, which can include a relatively slow stepper motor with a very fast piezoelectric driver. These techniques are not able to meet customers' future demands for wavelength stability as the demands push toward about 0.03 pm.

One approach to wavelength correction utilizes a rotation motor, such as a DC or stepper motor. Such motors are cheap and well developed. The control of these motors is simple, allowing long distances to be reached and providing high gear ratios. A big disadvantage of these DC or stepper motors is that the rotation has to be transferred to a translation movement. Such transfer requires a specially-designed mechanical set-up that includes a number of mechanical contact surfaces, which leads to mechanical play. A high gear ratio also can result in a higher level of play in the gear. When using DC motors with brushes, the brushes wear out over time such that regular maintenance is necessary.

These motors also demonstrate increased heating once the target position is reached, as well as during adjustment of the complete mechanism. While this increased heating might not be a significant problem for DC motors, as no current is flowing through the motor when the target is reached, heating of a motor is more intensive when using stepper motors, due at least in part to the continuous conduction of current in the coils of the stepper motor. Dynamics such as speed and acceleration in a DC motor are higher than those of stepper motors.

As described above, existing mechanical arrangements can be used to adjust the optical elements in excimer or molecular fluorine lasers. In order to obtain a precise working of the optic module, vibrations in the module due to the use of a DC motor or stepper motor may require damping. Vibrations can be especially problematic when utilizing stepper motors, necessitating use of such damping elements. The target position can be reached without overshoot when using stepper motors, but a closed-loop circuit is necessary for error compensation when using a DC motors. The optic module is purged by nitrogen or a rare gas, or is evacuated. When using an evacuated optics module, motors installed inside the module need to be designed for the operation under vacuum conditions, or need to utilize a vacuum tight feed through.

Instead of using a DC or stepper motor, certain existing systems utilize a piezo-ceramic stack device. Such a device can utilize piezo-based actuators and electrostrictive units. While these piezo-based devices can be well-suited for micro-positioning, the repetitive accuracy of such devices is rather poor due to the high amount hysteresis and long-time drift. Electrostrictive drives have been developed which exhibit far less hysteresis and drift, but the minimum increment of movement that can be obtained with such drives in on the order of about 5.0 nm.

Both electrostrictive and piezo-electric materials expand or contract based upon the voltage applied to the materials. An electrostrictive drive typically utilizes a stack of PMN-crystals, while a piezo-electric drive typically relies on a stack of lead-zirconate-titanate crystals (PZT). In contrast to piezo-electric materials, the PMN-ceramics are not poled. Positive and negative voltage variations allow the material to expand in the direction of the electrical field, independent of polarity. As PMN ceramics are not poled, the material is considerably more stable than PZT and not subject to long-time drift. While a PMN stack has a high dynamic with nanometer resolution, a big disadvantage of such an approach is that the dynamic is too low for the stabilization of the wavelength. The tuning range which has to be covered is about 100 pm-200 pm, and a 100 nm mechanical movement corresponds to a wavelength change of 0.005 pm. A ratio of the tuning range to smallest step size of about 200,000:1 is needed, which cannot be reached with a piezo-stack drive.

In all of the above-mentioned approaches, the drive motor is positioned outside the evacuated chamber. These approaches add to the complexity of a laser device, as it is necessary to design a feedthrough for the drive mechanism, as well as to seal the evacuated chamber to prevent pressure and contamination problems.

### BRIEF DESCRIPTION OF THE DRAWINGS

FIG. 1 is a diagram of a basic resonator design of the prior art.

FIG. 2 is a diagram of a motor system of the prior art.

FIGS. 3 is a diagram of an optics module that can be used in accordance with various embodiments of the present invention.

FIGS. 4(a) and (b) are diagrams of a piezo-ceramic motor that can be used in accordance with one embodiment of the present invention.

FIG. 5 is a diagram of a piezo-ceramic motor configuration that can be used in accordance with one embodiment of the present invention.

FIG. 6 is a diagram of a piezo-ceramic motor configuration that can be used in accordance with another embodiment of the present invention.

FIG. 7 is a diagram of a voice coil actuator.

FIG. 8 is a diagram of a linear voice coil actuator configuration that can be used in accordance with another embodiment of the present invention.

FIG. 9 is a diagram of a linear voice coil actuator configuration that can be used in accordance with another embodiment of the present invention.

FIG. 10 is a diagram of a motor configuration that can be used in accordance with embodiments of the present invention.

FIG. 11 is a diagram of a motor configuration in accordance with one embodiment of the present invention.

FIGS. 12(a), (b), (c), and (d) are diagrams showing 4-point-bearing assemblies that can be used in accordance with embodiments of the present invention.

FIG. 13 is a diagram of an overall excimer or molecular fluorine laser system that can be used in accordance with embodiments of the present invention.

### DETAILED DESCRIPTION

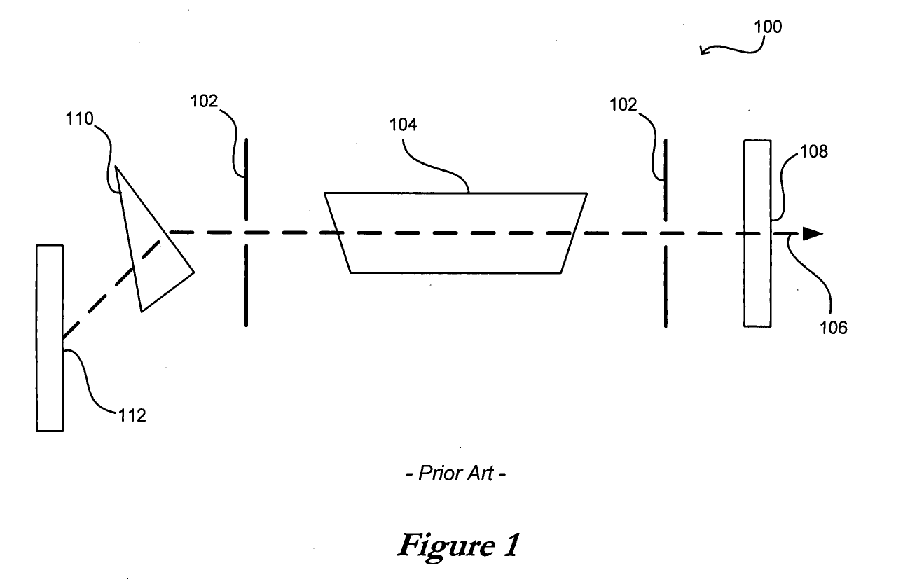

FIG. 1 shows a basic resonator layout 100 of the prior art, which can be used in accordance with embodiments of the present invention. The laser resonator includes a grating 112 which functions as a resonator mirror, a laser tube 104 or discharge chamber for generating an optical discharge, and an outcoupler 108 capable of outcoupling the beam 106 and acting as a second resonator mirror. At least one prism 110 can be inserted into the resonator between the laser tube 104 and the grating 112 as is known in the art. An aperture 102 can be inserted in the beam path between the laser tube 104 and the outcoupler 108, and/or between the laser tube 104 and the prism 110. Each aperture can serve to reduce the acceptance angle of the resonator and further reduce the output emission bandwidth.

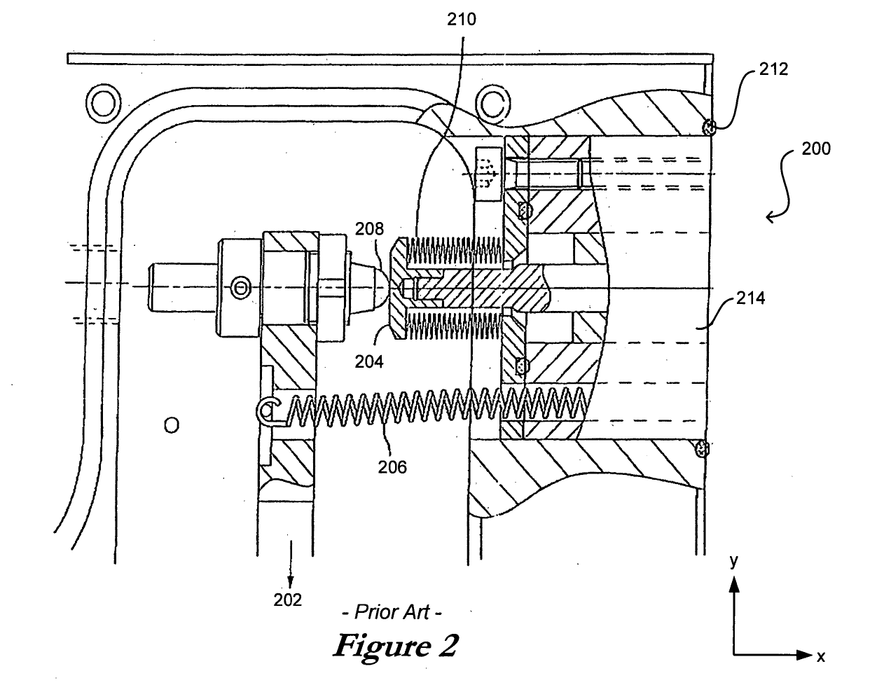

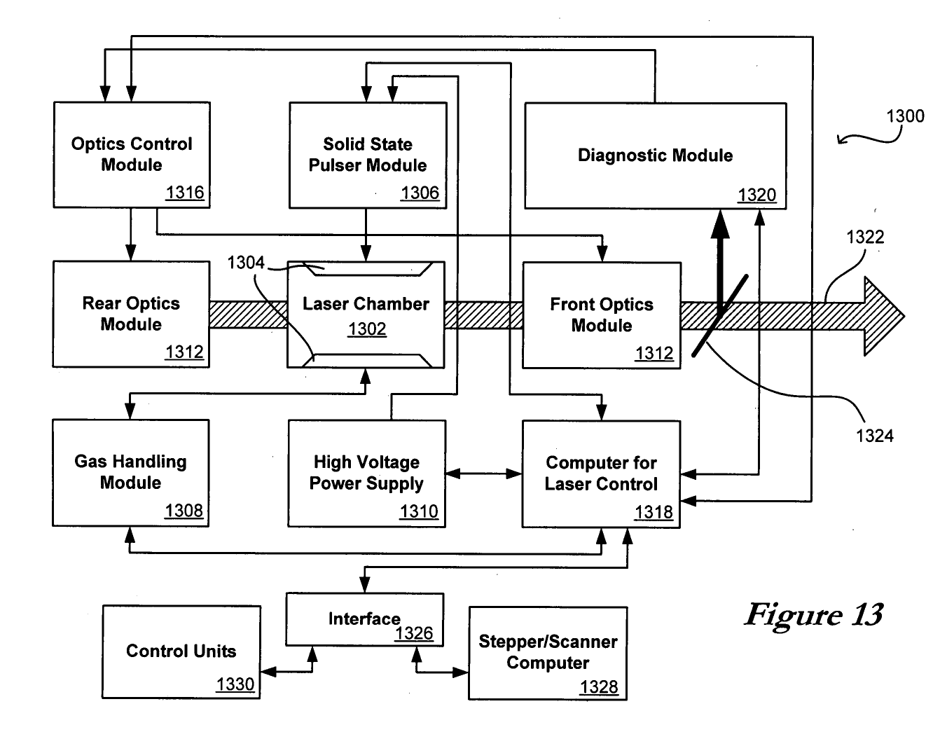

FIG. 2 shows a diagram of a motor drive setup 200 of the prior art that can be used for wavelength stabilization, as one or more line-narrowing and/or selection optics can be tuned by rotation. Line-narrowing and/or selection optics can include optics such as gratings, beam expanders, interferometric devices, and wavefront compensation optics, as known in the art. A lever 202 can be coupled to a rotational stage (not shown) having the optic mounted thereon. The lever 202 can be at least partially located within the line-narrowing module, e.g. a rear optics module as shown in FIG. 13, of the resonator. The line-narrowing module can be evacuated, or purged with helium, nitrogen, or another rare gas. The lever 202 can be supported by a spring 206, which can hold a knob end 208 of the lever 202 tight against a motor driven flange 204. The motor driven flange 204 can adjust in either direction along the x-axis through force applied by a motor 214, thereby moving the lever 202 and turning the optic in order to tune the wavelength of light output by the laser. The motor drive flange 204 and the motor 214 can feed into the evacuated or purged line-narrowing module under seal, such as by using O-rings 212 and a bellow 210. The body of the motor 214 is positioned outside the evacuated chamber. A drive portion of the motor 214 can be coupled by the bellow 210 to the lever 202 of the optics block, outside the evacuated area. An advantage to sealing the motor with respect to the chamber is that impurities can be prevented from leaving the motor 214 and entering the line-narrowing module and/or chamber. Also, having a motor such as a stepper motor located outside the evacuated chamber avoids design and implementation concerns and difficulties that would come from trying to operate the motor inside the evacuated chamber. A wavelength stability of ±0.06 pm can be reached using such an approach. As discussed above, stability in such a range is not sufficient to meet the ever-increasing demands on stability.

In addition to the improving stability, a high repetition rate excimer or molecular fluorine laser system above about 2 kHz can require compensation for wavelength chirp. Excimer and molecular fluorine lasers typically can be operated in burst mode, generating “bursts” of pulses, such as 100 to 500 pulses at a constant repetition rate, followed by a burst break or pause of from a few milliseconds up to a few seconds while the stepper/scanner does wafer positioning. During this pause, the laser can be shifted to a low duty cycle, such as on the order of 50 Hz compared to about 2 kHz or more during the burst. Alternatively, there may be no pulses generated during the pause. A burst break can be a short break, such as may occur when the beam spot is moved to a different location on a same wafer. A burst break also can be relatively long, such as would occur when a stepper/scanner changes between wafers. When an excimer or molecular fluorine laser is operated in burst mode, the first few pulses of each burst can have a varied wavelength if left uncompensated. This variance at the beginning of bursts, hereinafter referred to as “wavelength chirp,” can result from the cooling of optics, as well as corresponding changes in refractive index of the optics that occur during burst pauses. It can be necessary to compensate for wavelength chirp in order to obtain laser pulses of a constant wavelength. Wavelength chirp is discussed in more detail in pending U.S. patent application Ser. No. 10/165,766, entitled “CHIRP COMPENSATION METHOD AND APPARATUS,” to Hans-Stephan Albrecht et al., filed Jun. 6, 2002, which is hereby incorporated herein by reference. The regulation period necessary to compensate for wavelength chirp is typically limited by the motor and data recording, such as on the order of about 40 ms for a DC motor configuration. The variation in wavelength between the motor movements can be on the order of about 0.08 pm.

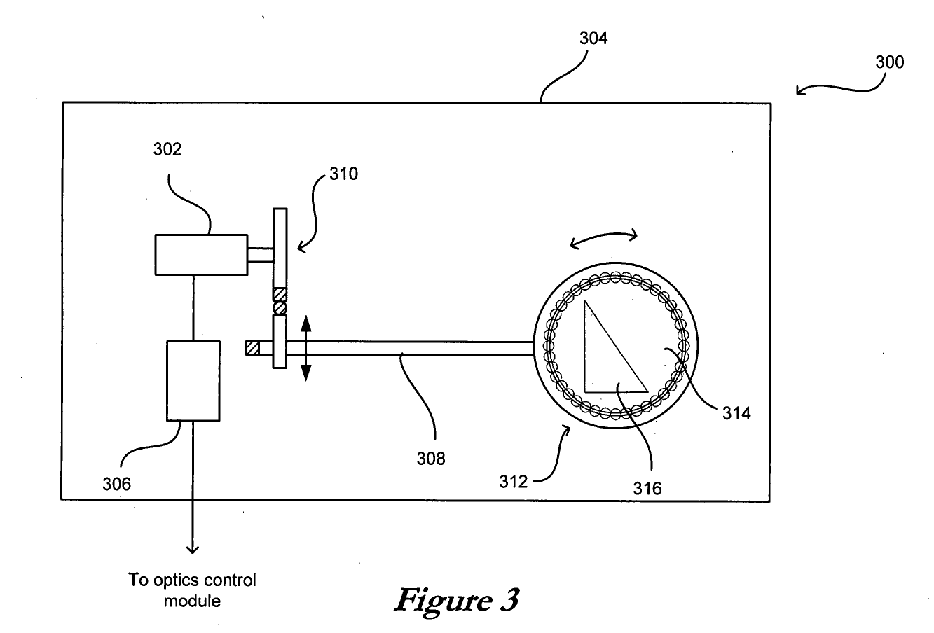

Systems and methods in accordance with various embodiments of the present invention can overcome disadvantages and deficiencies in existing laser systems while meeting the increasing demands on stability. For instance, FIG. 3 shows an optics module 300 that can be used with a gas discharge laser in accordance with embodiments of the present invention. The optics module 300 can have a tuning motor 302 contained within the evacuated optics module housing 304. The tuning motor can be any appropriate high-precision motor, as described below. A motor drive unit 306 can receive a drive signal from an optics control module (not shown), causing the tuning motor 302 to drive a lever 308 using a coupling assembly 310. The lever 308 can be coupled with a bearing assembly 312, which includes a table portion 314 upon which a prism 316 or other tuning element can be mounted. Such a module can allow the motor to be contained within the module housing, without the need for baffles or other sealing devices. Such an approach also can simplify laser design as it is no longer necessary to feed a drive mechanism of a motor into the discharge chamber in order to impart motion unto the tuning element.

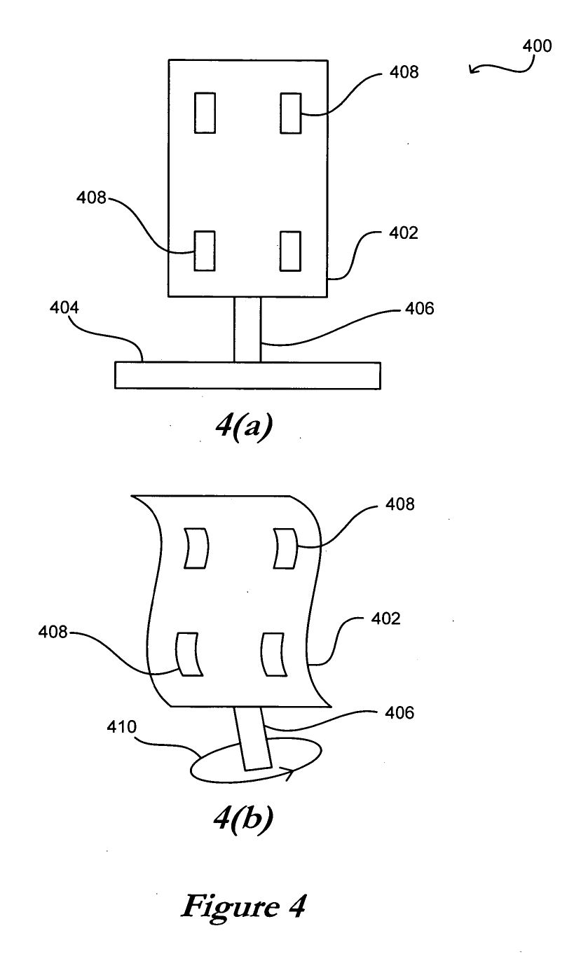

An example of a motor that can be used in an optics module such as the one shown in FIG. 3 is a piezo-ceramic motor assembly as shown in FIGS. 4(a) and 4(b), which combines the outstanding positional resolution of conventional piezo-based drive assemblies with wide ranges of control at a high traversing rate. Such a drive motor is extremely compact in profile, which enables for a space-saving installation. No intermediate mechanical elements such as gear transmissions and screws are needed, such that usability is not restricted by backlash. Further, there are no greases or lubricants used in such a motor, such that there is no need for a bellow in the discharge chamber or worry of such contaminants passing from the motor into the chamber interior. A piezo-ceramic motor 402 can have several contacts 408 where an external voltage can be applied, such as from a voltage source or control circuit. An armature gib 406 in contact with the motor can act onto a plate 404, the position of which can be adjusted when a voltage is applied to the contacts 408. The plate 404 and the armature gib 406 are made of a ceramic material in one embodiment, although other appropriate materials can be used. As can be seen in FIG. 4(b), the shape of the piezo-ceramic motor 402 can change when a proper voltage is applied to the contact regions 408. A micro-elliptic movement 410 of the armature gib 406 can result when an AC voltage is applied to the contacts 408, although other movement patterns are possible depending on the motor used.

A piezo-ceramic drive in accordance with one embodiment can consist of a stator component housing piezo-ceramic oscillating bars (not shown), which can be a preferable configuration for many applications. These oscillating bars can resiliently act onto an armature gib mounted on the moving part of the slide. The shaft-shaped piezo elements can oscillate when electrically excited in two superimposed vibration forms, namely longitudinal vibrations and bending vibrations. These vibrations can be excited by a bi-modal natural frequency of 40 kHz, creating an upright waveform inside the bars. Superimposing these waveforms can initiate micro-elliptic movement on the ends of the bars. As the bars are resting on the armature gib under mechanical pre-load, the bars can transfer a driving pulse onto the armature. This procedure can run in half the cycle time, with a typical cycle time being on the order of about T=25 μs. Continuing the phase of movement, each contact bar can return into the initial position without any application of force. Due to the high frequency, a constant feed force can act onto the armature depending on the control voltage. The control voltage that is applied to a piezo-ceramic motor driver unit module can determine the vibration amplitude and force, while the magnitude of the frequency can remain unchanged. The speed can depend on the applied load, and can drop nearly linear with force.

Piezo-ceramic motors currently can reach a maximum speed of more than 350 mm/s. In states where no voltage is applied, a piezo-ceramic motor can act as a brake to apply a defined, maximum holding force. The force range can depend in one embodiment on the number of piezo oscillators. Several piezo-ceramic motors can be arranged on a single axis in order to increase the amount of force, and can be synchronously driven by a driver unit module. The piezo oscillators can be tipped with sliding shoes, which can be made of hard ceramics running on lapped ceramic gibs serving as tracks. Such mating can ensure long lasting operation over 20,000 hours at a load variation rate of approximately 50% of continuous duty. In an embodiment where a rotary drive is used, the rotary drive can be composed of a radial installation of piezo-ceramic motors on the circumference of a cylinder, using a ceramic ring as a track, or an axial assembly acting on a ceramic disk.

Piezo-ceramic motors are characterized by not having interfering magnetic fields, as well as being insensitive to external magnetic fields. These motors have neither gears nor rotating shafts, but have a displacement based on solid-state phenomena which exhibits no wear and tear. Piezo actuators can employ ceramic elements that do not need lubricant and that exhibit no wear or abrasion, making the elements clean-room compatible and well suited for vacuum applications. No vacuum feedthroughs are necessary when the piezo actuators are installed inside of an evacuated housing. The materials of the piezo actuators can be selected such that the materials are resistant against UV light, and no impurities from the materials will leak into the optic module(s).

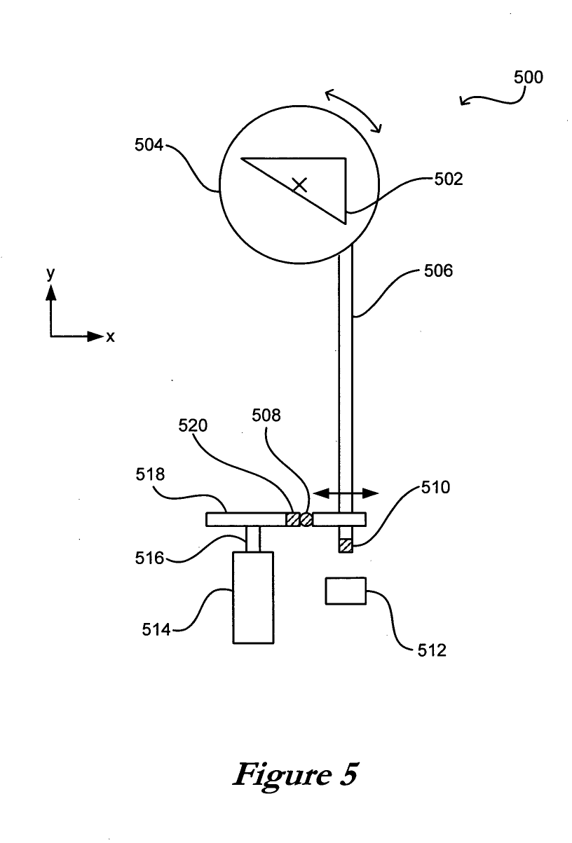

FIG. 5 shows a mechanical configuration 500 that can be used in a discharge chamber or optics module, wherein a piezo-ceramic motor 514 is used to stabilize the wavelength of an excimer or molecular fluorine laser by rotating a prism 502, which can be utilized as shown in the arrangements of FIGS. 1 and 2. The prism 502 can be mounted onto a plate (not shown), which is in turn mounted onto a bearing assembly 504. The prism 502 can be rotated when a voltage is applied to the piezo-ceramic motor 514. An armature gib 516 can transfer a force to a positioning plate 518, which can be moved in either direction along the x-axis in the Figure. When the positioning plate 518 is moved, a motion transfer lever 506 can transfer the linear movement of the positioning plate 518 to a rotary movement of the bearing, and hence the prism 502. A flexible and/or moveable coupling mechanism can be used between the motion transfer lever and the positioning plate, in order to allow the linear motion of the plate to be transferred to a rotating motion of the lever. In one embodiment, such a coupling mechanism can include a magnetic ball 508 mounted to, or held in contact with, the lever 506. The magnetic ball also can be in contact with a magnet 520 of the positioning plate 518. Using this ball/magnet arrangement, the motion of positioning plate 518 can be transferred to the lever 506. Other coupling and/or connection mechanisms are possible that are not described in detail herein. The movement of the motion transfer lever 506 can be controlled by a combination of a scale 510 mounted onto the lever 506 and a detection system 512 capable of reading the scale contact-free. The detection unit can be any appropriate position feedback device, such as may include a scanner, laser encoder, or camera system. A signal from the detection unit 512 can be sent for data processing in a diagnostic module of the laser system or a separate motor controller. Such detection units can be obtained, for example, from Renishaw, having offices in New Mills, Wotton-under-Edge, Gloucestershire, GL12 8JR, United Kingdom. Renishaw model RGH25F with interface unit RGF2000 (10 nm resolution) can be used. Further detection units are available from Dr. Johannes Heidenhain GmbH, Dr.-Johannes-Heidenhain-Strasse 5, 83301 Traunreut, Germany.

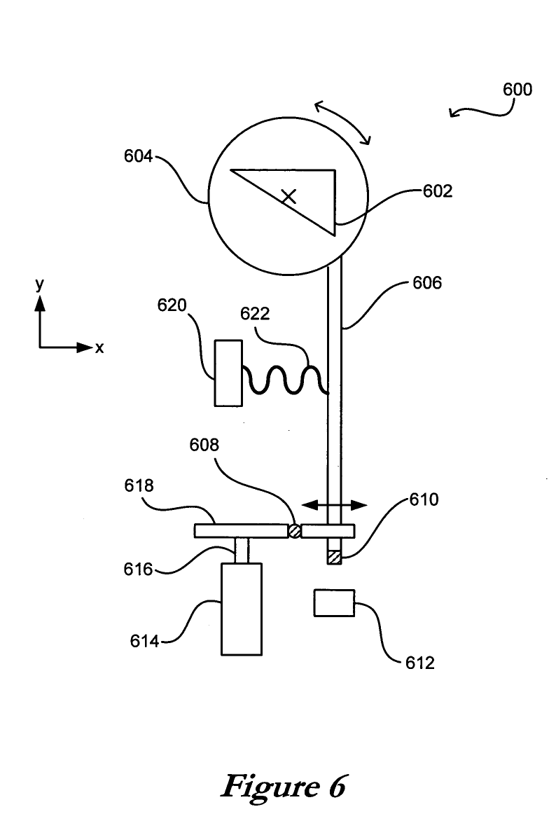

In the configuration 600 of FIG. 6, the ball/magnet arrangement is replaced by a ball/spring arrangement. A ball/spring arrangement can be preferable in certain situations, as springs are available in many types, sizes, and strengths, and are relatively easy to assemble. The ball 608 in this arrangement is always in contact with the plate 618, due to a force applied by the spring 622, which is mounted onto the lever 606. Part 620 can act as a mount for the spring 622, which can be rigidly attached to the discharge chamber or optics module housing, for example. The other parts of FIG. 6 have been described above, such that the numerals and parts are now only listed to include prism 602, bearing 604, ball 608, scale 610, detection unit 612, piezo-ceramic motor 614, and armature gib 616.

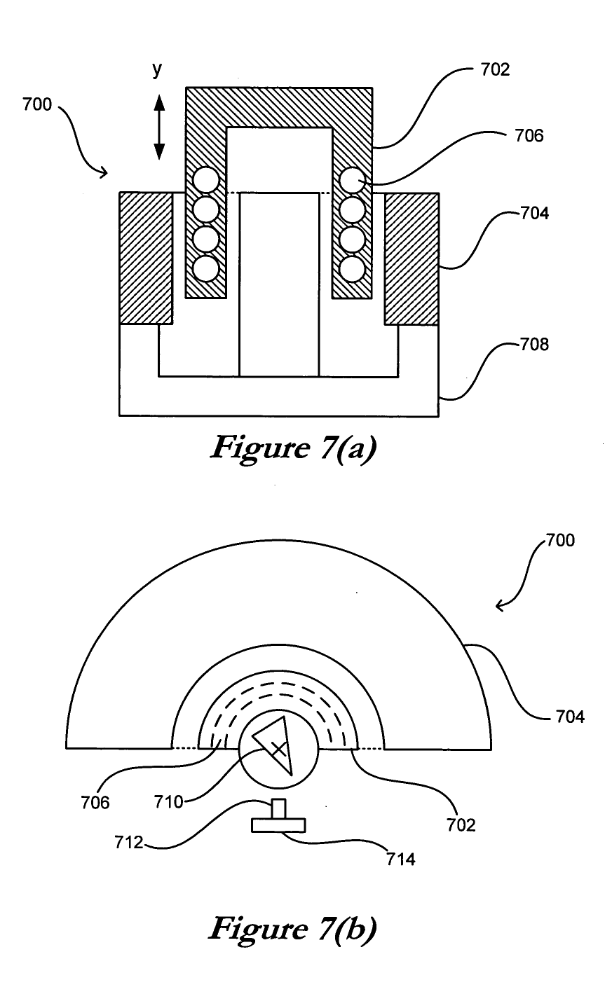

An alternative approach in accordance with another embodiment of the present invention involves a voice coil actuator, as shown in the configuration 700 of FIG. 7(a). A voice coil actuator can be a non-commutated, two terminal, limited motion device, for example, which can have linear control characteristics, zero hysteresis, zero cogging, and infinite position sensitivity. Such properties allow a voice coil motor to be preferable for many applications. Further, the electrical and mechanical time constants can be low, and the actuator can have a high output power to weight and volume ratio. The actuator can be a near-ideal servomechanism, which can be used to adjust an optical element, e.g. an optical element of an optic module as described above. Such a voice coil actuator can consist of two basic components, a moving member 702 and a fixed member 708, as shown in the cross-section in FIG. 7(a). A core of the moving member 702 can include a group of coiled wires in a tubular form, represented by circles 706 in the Figure. The stationary member can comprise a permanent magnet 704 surrounding the outer layer of the coil, and a ferromagnetic magnet of the inner structure that completes the magnetic field radiating through the coil of the moving member. By applying a voltage across the leads of the coil 706, the magnetic field can produce a force on the moving member, creating linear motion along the y-direction. Sufficiently accurate control can be obtained when the force is proportional to the current applied. Voice coil actuators are commercially available from BEI Technologies, Inc., with offices in 804-A Rancheros Drive, San Marcos, Calif. 92069 USA as linear or rotary devices. This device can be utilized, for example, inside the optics module of FIG. 3 and in place of the drive motor and lever assembly.

FIG. 7(b) shows a top-view of a rotary voice coil actuator, consisting of a magnet 702 and a coil 706 positioned in an interior region of a permanent magnet 704, similar to the voice coil of FIG. 7(a). Magnet 702 is a rotary part, on which an optical element 710, e.g. a prism, can be mounted. A position sensor consisting of parts 712 and 714 is shown to control the position of the optical element 710. For the above-described usage, a rotary voice coil actuator could be used, but the resolution which can be reached with such a device may be low for the stabilization of the wavelength of an excimer or molecular fluorine laser.

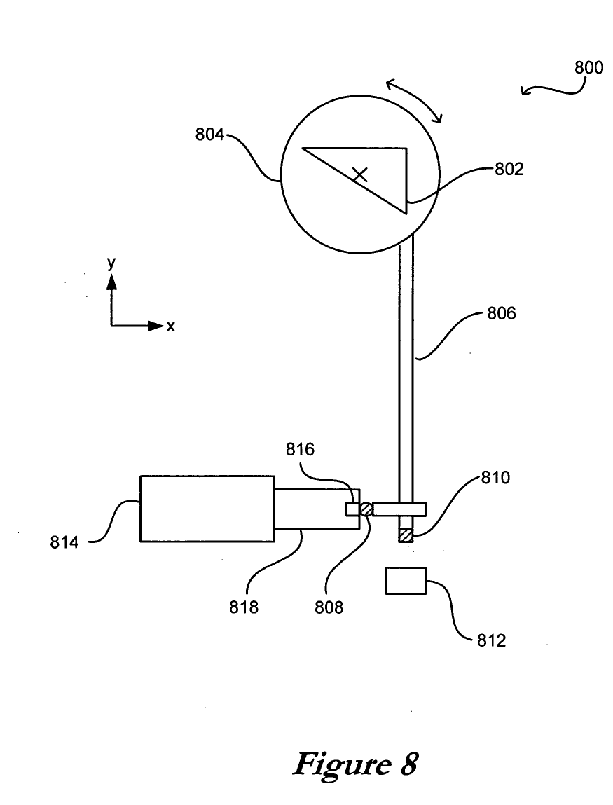

A lever can be used with a linear voice coil actuator in order to achieve a rotation as shown in FIG. 8. Voice coil Model LA 15-16-020 of BEI Technologies, Inc., can be used, which has a special ceramic bearing. A voice coil actuator 814 can be used to rotate the prism 802, mounted on a plate (not shown), which can be mounted on bearing assembly 804. When a voltage is applied to the voice coil actuator 814, the laterally moving part 818 of the actuator will move along the x-axis and transfer this linear movement via lever 806 to a rotary movement of the prism 802. The lever 806 can be connected through flexible or moveable coupling mechanism, such as a ball 808 and magnet 816 arrangement, to the voice coil actuator 814. A higher resolution can be reached with such a lever arrangement, in contrast to a rotary voice coil actuator. With a voice coil arrangement, movements of 1 μm in 5 ms can be obtained. An absolute accuracy of ±16 nm or better can be reached with such a set-up.

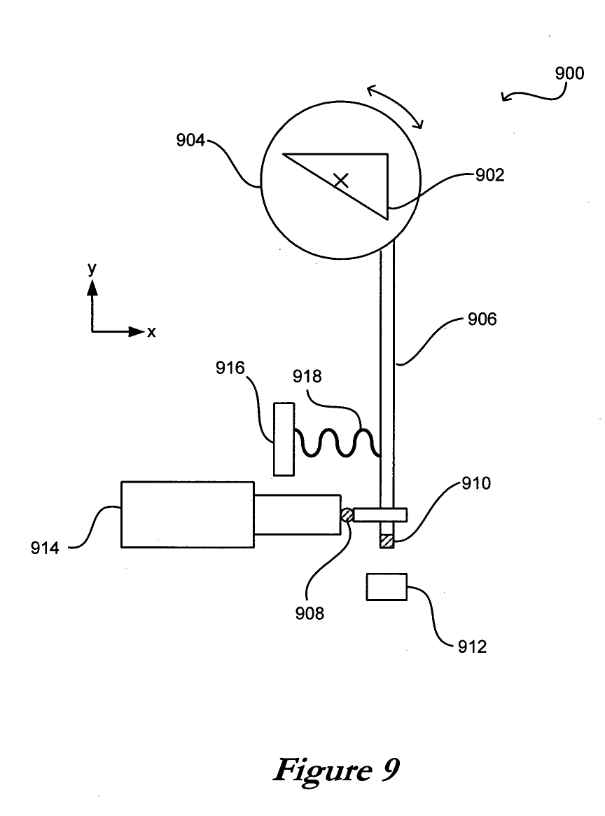

In the configuration 900 of FIG. 9, the ball/magnet arrangement of the flexible coupling mechanism is replaced by a ball/spring arrangement. The ball 908 can be in constant contact with the voice coil actuator 914 since the spring 918 is mounted onto the lever 906. Part 916 can be used to mount the spring 918 to the walls of the discharge chamber or the optics module housing, for example. The other parts of FIG. 9 have been described in detail in the text above. For this reason only the numerals and parts are listed, including prism 902, bearing 904, ball 908, scale 910, detection unit 912, and moving part 920 of voice coil actuator. Alternatively, a solid link can be used.

Linear and rotary potentiometers can be used to sense position information in servo systems utilizing voice coil technology. Other devices can be used when special considerations, such as high resolution or space limitations, preclude the use of potentiometers. Rotary feedback devices can include capacitive sensors, optical encoders, resolvers, inductosyns® (a registered trademark of Ruhle Companies, Inc., with offices in 99 Wall Street Valhalla, N.Y. 10595-1452, USA) or rotary variable differential transformers. Linear feedback devices can include optical encoders, inductosyns®, magneto-resistive sensors (contactless potentiometers), and linear variable differential transformers. To move an optical element installed in an optic module, for example, the optical element can be flanged to a rotary voice coil actuator by a plate, such that no additional lever arrangement is necessary to rotate the prism. Any play caused by complicated mechanical set-ups can be avoided. With such a device, wavelength changes of approximately 0.05 pm are possible.

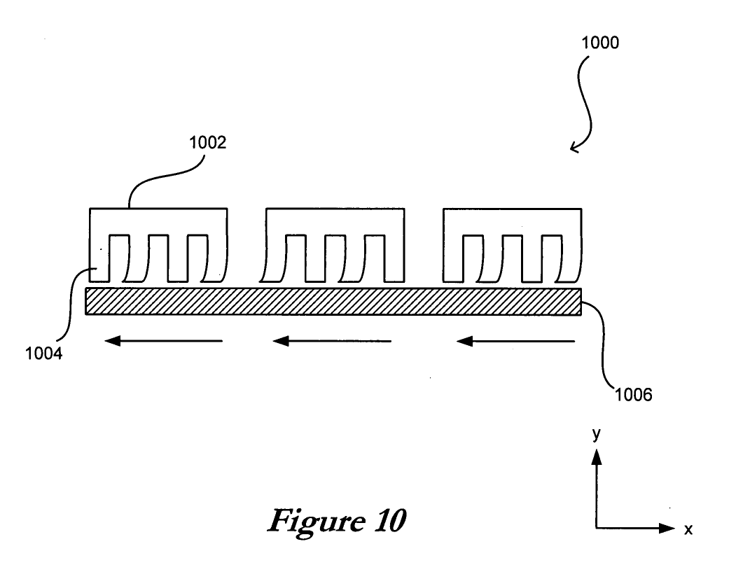

A configuration in accordance with another embodiment can utilize a piezo motor driver unit, such as a piezo LEGS™ motor as described in U.S. Pat. No. 6,184,609, incorporated herein by reference, which is commercially available from PiezoMotor Uppsala AB, Sylveniusgatan 5D, SE-754 50 Uppsala, Sweden. Such a motor uses the piezoelectric effect, and consists of a solid body with movable legs. The piezo material elongates and bends as a result of an applied voltage on the different halves of each leg. A reduction in the driving voltage can be obtained when the motor is composed of thin piezoceramic layers with a conducting material between each layer. The motor can comprise more than 100 layers, such that the motor can be driven by battery voltages. Each leg can consist of ceramic parts that can be controlled by an electric field, such that the motor can set down or raise each leg, as well as bending each leg forward or backward. The motor 1002 can walk across a surface 1006 when using the synchronized movement of its legs 1004, such as is shown in FIG. 10. In this four-leg example, one pair of legs is lifted off the surface 1006 while the other pair makes contact with the surface. This allows the motor to walk step-by-step across the surface. The steps are relatively small, such as on the order of a couple thousandths of a millimeter, but by taking up to 10,000 steps per second the motor can reach a speed of several centimetres per second. By partially bending a pair of legs instead of taking a complete step, the motor can move with a resolution on the order of a millionth of a millimeter, down to about 10 nanometers. Such a piezo motor driver unit can function as a robust motor, as the motor is comprised of a single piece of material. Conventional electric motors are assembled from several parts, which may include a rotor, a stator, and ball bearings, as well as other components. The motor operates directly, such that no gears or other mechanical power transmission is necessary. Such a motor is relatively small, typically on the order of about 5 mm-20 mm in length, 1 mm-5 mm in width, and 2 mm-8 mm in height, and can lift about 1,000 times its own weight. The driving voltage can be between about 4.0 V-48 V, and the motor can be used in a temperature range of about −20° C. to about +70° C. The dynamic force currently can extend to 8 N. Under normal conditions, the piezo-ceramic material of the motor is resistant against fatigue and wear-and tear. Special care can be taken when choosing the surface on which the motor is walking, as the drive surface of the legs and the surface on which the legs walk can be subjected to wear-and-tear. The wear on the surfaces can be minimized by adjusting the movement of the legs in order to grip the surface softly and smoothly. It also is possible to add a wear-resistant sole to each leg. These motors can function optimally in a closed-loop system where the feedback can come from a position sensor such as a linear encoder.

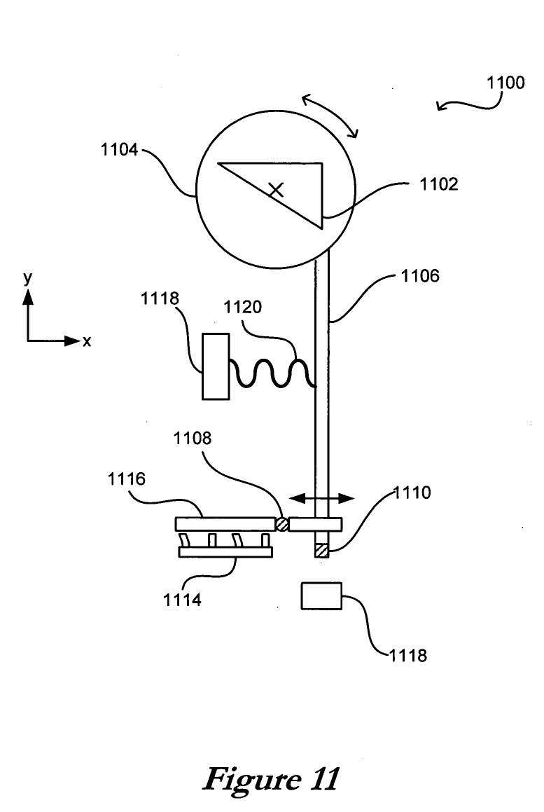

FIG. 11 shows a configuration 1100 that can be used to stabilize the wavelength of an excimer or molecular fluorine laser. A prism 1102 can be mounted to a plate (not shown), which in turn is mounted onto a bearing assembly 1104. The prism 1102 can be rotated when a voltage is applied to the piezo motor 1114. The legs of the piezo motor can transfer a force to a motion transfer plate 1116, such that the transfer plate can be moved in either direction along the x-axis in the Figure. When the motion transfer plate 1116 is moved, the lever 1106 can transfer the linear movement of the plate 1116 to a rotary movement of the prism 1102. A magnetic ball 1108 can be mounted onto the lever 1106, which can be in contact with a magnet (not shown) using a ball/magnet arrangement as discussed above. Alternatively, another flexible or moveable coupling mechanism can be utilized, such as a ball/spring arrangement, as described above, which utilizes spring 1120 and mounting piece 1118, which can be mounted to the chamber walls or module housing. Other coupling mechanisms such as those described above are possible but not described in detail herein.

Many of the embodiments described above also can be installed inside an optics module, or line-narrowing module. For this reason, these embodiments can be designed and manufactured in such a way as to be used under vacuum conditions, as well as being resistant to UV light.

Improved Bearings

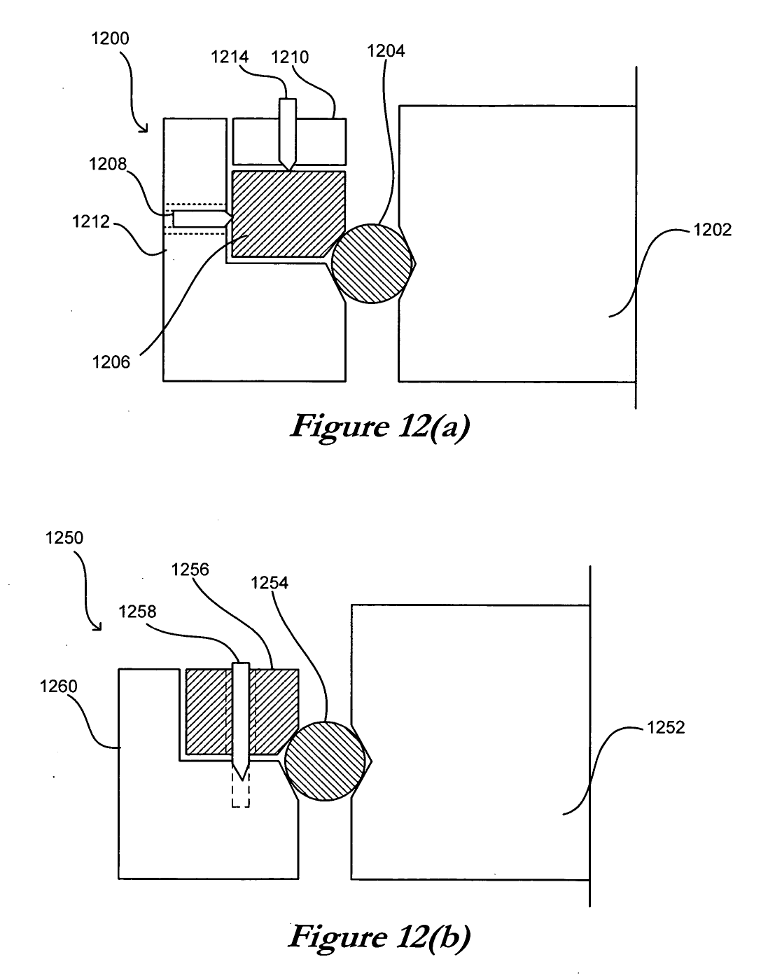

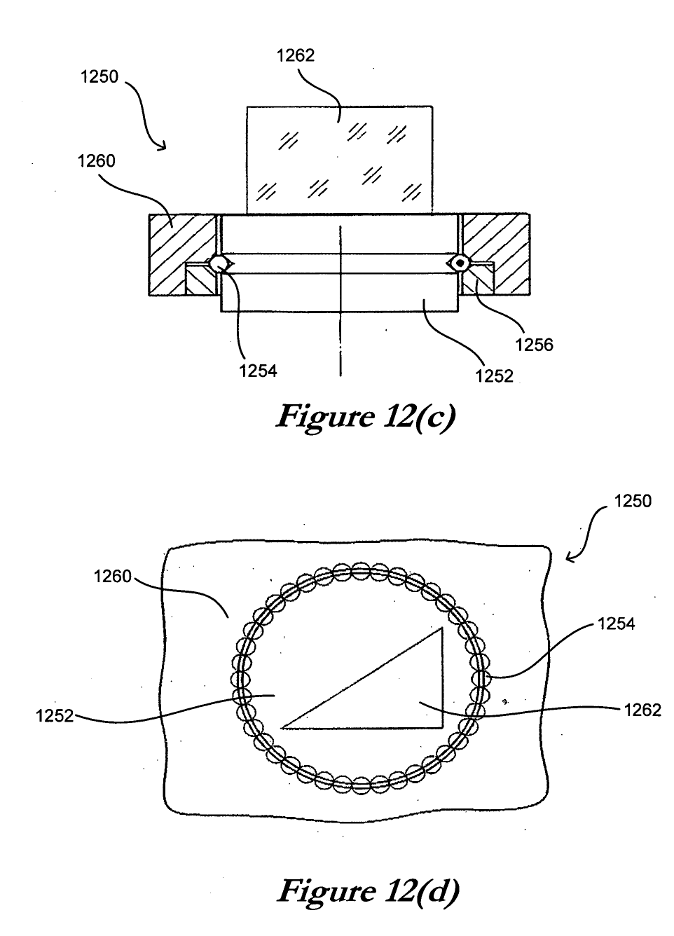

As shown in the diagram of FIG. 3, systems and methods in accordance with various embodiments of the present invention can utilize an improved bearing assembly, onto which the optical element is mounted, which can be rotated by a lever as described above. Presently, commercially available bearings cannot be used when stabilizing wavelength. Instead, a 4-point-bearing can be used, which works without any lubricant. The lack of lubricant can be important for DUV or VUV optical modules. FIG. 12(a) shows a cross-section of a portion of an exemplary 4-point-bearing assembly, such as is shown in FIG. 3. Here, the 4-point-bearing consists of bearing bodies 1202 and 1212. The ball 1204 is in contact with four surfaces, two of the outer, stationary body and two of the inner, rotatable body, and can be adjusted by an adjusting ring 1210 and a bearing ring 1206, which can be used with either body, but may advantageously be used with the stationary body. The bearing ring 1206 can in turn be adjusted by a grub screw 1208. Adjusting ring 1210 can allow for both an axial and a radial adjustment. Adjusting screw 1214 can be used for fine adjustment and to fix the operation position. In one embodiment, twelve or more screws 1214 can be used for adjustment purposes. A plurality of bearings can occupy the channel formed between the two bodies, allowing the bodies to rotate with respect to each other.

FIG. 12(b) shows a cross-section of a portion of another exemplary 4-point-bearing assembly 1250. Here, the 4-point-bearing consists of bearing bodies 1252 and 1260. Each ball bearing 1254 in the assembly is in contact with four surfaces, and can be adjusted by a single adjusting ring 1256, which can be adjusted by grub screw 1258. FIG. 12(c) shows a side view of the bearing assembly 1250 having an optical element 1262 placed thereon for rotation of the element as described above. FIG. 12(d) shows a top view of a portion of the bearing assembly 1250 and optical element 1262, showing the ring of bearings that can be positioned in a channel between the bearing bodies 1252, 1260. Possible hardened materials for the bearing the materials include 17350 (German DIN, German Institute for Standardization) and 17440 (German DIN). These materials can be hardened to minimum 58 HRC, and up to 64 HRC. The surface quality of the contact surface can be below Rz 0.4. The balls 1204, 1254 in each arrangement can be made of metal, a metal alloy, or a ceramic. The arrangement of FIG. 12(b) can be preferable for many applications, as the arrangement of FIG. 12(a) can in some instances exhibit problems such as self-blocking.

In wavelength stabilization systems, bearings have shown surface damage where the balls contact the surface(s). Bearings can begin to show small tears under the surface, which eventually move to the surface to produce pittings on the surface. To overcome this problem, the surfaces of a bearing can be treated using one of a number of special techniques. One such technique is to use a Graphit-iC™ coating. Graphit-iC™ is a registered trademark of MULTI-ARC INC. CORPORATION DELAWARE, 1990 Christensen Avenue West, St. Paul, Minn., 55118. Graphit-iC™ is a carbon coating that may be produced by sputtering graphite targets in a pure Ar atmosphere using a closed field unbalanced magnetron system, as described for example in U.S. Pat. No. 5,556,519). Graphit-iC™ has improved tribological properties when compared to standard DLC (diamond-like carbon) coatings, and is currently available as a pure carbon or multiplayer coating. Coatings made of Graphit-iC are dark, electrically conductive, and have a graphitic microcrystalline structure which exhibits high hardness, around 2500HV, with high elastic recovery seen in the load-unload curve, low friction, high wear resistance, and excellent adhesion. A metallic interlayer also can provide excellent adhesion, yielding a scratch test critical load above 70N. Coatings of a thickness of up to 5 μm can be deposited in one embodiment. The friction. coefficient can be between about 0.05 and about 0.09, depending upon conditions. The specific wear rate is presently 3×10⁻¹⁷ m³/Nm in ambient conditions, and 5×10⁻¹⁸ m³/Nm-Graphit-iC™ against Graphit-iC™. The parts can be cleaned by a process such as plasma etching before being coated. When compared to DLC coatings, Graphit-ic™ has lower friction coefficients, such as 0.06 compared to 0.12, a lower specific wear rate, improved by about an order of magnitude, and a higher load-bearing capacity. Where necessary, multiple bearing balls, or balls of different sizes (such as balls of 3-4 m in diameter), can be used to minimize bearing blockage.

Laser System

FIG. 13 shows components of an excimer or molecular fluorine laser system 1300 that can be used in accordance with various embodiments of the present invention. The gas discharge laser system can be a deep ultraviolet (DUV) or vacuum ultraviolet (VUV) laser system, such as an excimer laser system, e.g., ArF, XeCl or KrF, or a molecular fluorine (F₂) laser system for use with a DUV or VUV lithography system.

The laser system 1300 includes a laser chamber 1302 or laser tube, which can include a heat exchanger and fan for circulating a gas mixture within the chamber or tube. The chamber can include a plurality of electrodes 1304, such as a pair of main discharge electrodes and one or more preionization electrodes connected with a solid-state pulser module 1306. A gas handling module 1308 can have a valve connection to the laser chamber 1302, such that halogen, rare and buffer gases, and gas additives, can be injected or filled into the laser chamber, such as in premixed forms for ArF, XeCl and KrF excimer lasers, as well as halogen, buffer gases, and any gas additive for an F₂ laser. The gas handling module 1308 can be preferred when the laser system is used for microlithography applications, wherein very high energy stability is desired. A gas handling module can be optional for a laser system such as a high power XeCl laser. A solid-state pulser module 1306 can be used that is powered by a high voltage power supply 1310. Alternatively, a thyratron pulser module can be used. The laser chamber 1302 can be surrounded by optics modules 1312, 1314, forming a resonator. The optics modules 1312, 1314 can include a highly reflective resonator reflector in the rear optics module 1312, and a partially reflecting output coupling mirror in the front optics module 1314. This optics configuration can be preferred for a high power XeCl laser. The optics modules 1312, 1314 can be controlled by an optics control module 1316, or can be directly controlled by a computer or processor 1318, particularly when line-narrowing optics are included in one or both of the optics modules. Line-narrowing optics can be preferred for systems such as KrF, ArF or F₂ laser systems used for optical lithography.

The processor 1318 for laser control can receive various inputs and control various operating parameters of the system. A diagnostic module 1320 can receive and measure one or more parameters of a split off portion of the main beam 1322 via optics for deflecting a small portion of the beam toward the module 1320. These parameters can include pulse energy, average energy and/or power, and wavelength. The optics for deflecting a small portion of the beam can include a beam splitter module 1324. The beam 1322 can be laser output to an imaging system (not shown) and ultimately to a workpiece (also not shown), such as for lithographic applications, and can be output directly to an application process. Laser control computer 1318 can communicate through an interface 1326 with a stepper/scanner computer, other control units 1328, 1330, and/or other, external systems.

The laser chamber 1302 can contain a laser gas mixture, and can include one or more preionization electrodes in addition to the pair of main discharge electrodes. The main electrodes can be similar to those described at U.S. Pat. No. 6,466,599 B1 (incorporated herein by reference above) for photolithographic applications, which can be configured for a XeCl laser when a narrow discharge width is not preferred.

The solid-state or thyratron pulser module 1306 and high voltage power supply 1310 can supply electrical energy in compressed electrical pulses to the preionization and main electrodes within the laser chamber 1302, in order to energize the gas mixture. The rear optics module 1312 can include line-narrowing optics for a line narrowed excimer or molecular fluorine laser as described above, which can be replaced by a high reflectivity mirror or the like in a laser system wherein either line-narrowing is not desired (XeCl laser for TFT annealling, e.g.), or if line narrowing is performed at the front optics module 1314, or a spectral filter external to the resonator is used, or if the line-narrowing optics are disposed in front of the HR mirror, for narrowing the bandwidth of the output beam.

The laser chamber 1302 can be sealed by windows transparent to the wavelengths of the emitted laser radiation 1322. The windows can be Brewster windows, or can be aligned at an angle, such as on the order of about 5°, to the optical path of the resonating beam. One of the windows can also serve to output couple the beam.

After a portion of the output beam 1322 passes the outcoupler of the front optics module 1314, that output portion can impinge upon a beam splitter module 1324 including optics for deflecting a portion of the beam to the diagnostic module 1320, or otherwise allowing a small portion of the outcoupled beam to reach the diagnostic module 1320, while a main beam portion is allowed to continue as the output beam 1320 of the laser system. The optics can include a beamsplitter or otherwise partially reflecting surface optic, as well as a mirror or beam splitter as a second reflecting optic. More than one beam splitter and/or HR mirror(s), and/or dichroic mirror(s) can be used to direct portions of the beam to components of the diagnostic module 1320. A holographic beam sampler, transmission grating, partially transmissive reflection diffraction grating, grism, prism or other refractive, dispersive and/or transmissive optic or optics can also be used to separate a small beam portion from the main beam 1322 for detection at the diagnostic module 1320, while allowing most of the main beam 1322 to reach an application process directly, via an imaging system or otherwise.

The output beam 1322 can be transmitted at the beam splitter module 1324, while a reflected beam portion is directed at the diagnostic module 1320. Alternatively, the main beam 1322 can be reflected while a small portion is transmitted to a diagnostic module 1320. The portion of the outcoupled beam which continues past the beam splitter module can be the output beam 1322 of the laser, which can propagate toward an industrial or experimental application such as an imaging system and workpiece for photolithographic applications.

For a system such as a molecular fluorine laser system or ArF laser system, an enclosure (not shown) can be used to seal the beam path of the beam 1322 in order to keep the beam path free of photoabsorbing species. Smaller enclosures can seal the beam path between the chamber 1302 and the optics modules 1312 and 1314, as well as between the beam splitter 1324 and the diagnostic module 1320.

The diagnostic module 1320 can include at least one energy detector to measure the total energy of the beam portion that corresponds directly to the energy of the output beam 1322. An optical configuration such as an optical attenuator, plate, coating, or other optic can be formed on or near the detector or beam splitter module 1324, in order to control the intensity, spectral distribution, and/or other parameters of the radiation impinging upon the detector.

A wavelength and/or bandwidth detection component can be used with the diagnostic module 1320, the component including for example such as a monitor etalon or grating spectrometer. Other components of the diagnostic module can include a pulse shape detector or ASE detector, such as for gas control and/or output beam energy stabilization, or to monitor the amount of amplified spontaneous emission (ASE) within the beam, in order to ensure that the ASE remains below a predetermined level. There can also be a beam alignment monitor and/or beam profile monitor.

The processor or control computer 1318 can receive and process values for the pulse shape, energy, ASE, energy stability, energy overshoot for burst mode operation, wavelength, and spectral purity and/or bandwidth, as well as other input or output parameters of the laser system and output beam. The processor 1318 also can control the line narrowing module to tune the wavelength and/or bandwidth or spectral purity, and can control the power supply 1310 and pulser module 1306 to control the moving average pulse power or energy, such that the energy dose at points on the workpiece can be stabilized around a desired value. In addition, the computer 1318 can control the gas handling module 1308, which can include gas supply valves connected to various gas sources. Further functions of the processor 1318 can include providing overshoot control, stabilizing the energy, and/or monitoring energy input to the discharge.

The processor 1318 can communicate with the solid-state or thyratron pulser module 1306 and HV power supply 1310, separately or in combination, the gas handling module 1308, the optics modules 1312 and/or 1314, the diagnostic module 1320, and an interface 1326. The processor 1318 also can control an auxiliary volume, which can be connected to a vacuum pump (not shown) for releasing gases from the laser tube 1302 and for reducing a total pressure in the tube. The pressure in the tube can also be controlled by controlling the gas flow through the ports to and from the additional volume.

The laser gas mixture initially can be filled into the laser chamber 1302 in a process referred to herein as a “new fill”. In such procedure, the laser tube can be evacuated of laser gases and contaminants, and re-filled with an ideal gas composition of fresh gas. The gas composition for a very stable excimer or molecular fluorine laser can use helium or neon, or a mixture of helium and neon, as buffer gas(es), depending on the laser being used. The concentration of the fluorine in the gas mixture can range from 0.003% to 1.00%, in some embodiments is preferably around 0.1%. An additional gas additive, such as a rare gas or otherwise, can be added for increased energy stability, overshoot control, and/or as an attenuator. Specifically for an F₂-laser, an addition of xenon, krypton, and/or argon can be used. The concentration of xenon or argon in the mixture can range from about 0.0001% to about 0.1%. For an ArF-laser, an addition of xenon or krypton can be used, also having a concentration between about 0.0001% to about 0.1%. For the KrF laser, an addition of xenon or argon may be used also over the same concentration.

Halogen and rare gas injections, including micro-halogen injections of about 1-3 milliliters of halogen gas, mixed with about 20-60 milliliters of buffer gas, or a mixture of the halogen gas, the buffer gas, and an active rare gas, per injection for a total gas volume in the laser tube on the order of about 100 liters, for example. Total pressure adjustments and gas replacement procedures can be performed using the gas handling module, which can include a vacuum pump, a valve network, and one or more gas compartments. The gas handling module can receive gas via gas lines connected to gas containers, tanks, canisters, and/or bottles. A xenon gas supply can be included either internal or external to the laser system.

Total pressure adjustments in the form of releases of gases or reduction of the total pressure within the laser tube also can be performed. Total pressure adjustments can be followed by gas composition adjustments if necessary. Total pressure adjustments can also be performed after gas replenishment actions, and can be performed in combination with smaller adjustments of the driving voltage to the discharge than would be made if no pressure adjustments were performed in combination.

Gas replacement procedures can be performed, and can be referred to as partial, mini-, or macro-gas replacement operations, or partial new fill operations, depending on the amount of gas replaced. The amount of gas replaced can be anywhere from a few milliliters up to about 50 liters or more, but can be less than a new fill. As an example, the gas handling unit connected to the laser tube, either directly or through an additional valve assembly, such as may include a small compartment for regulating the amount of gas injected, can include a gas line for injecting a premix A including 1% F₂:99% Ne, and another gas line for injecting a premix B including 1% Kr:99% Ne, for a KrF laser. For an ArF laser, premix B can have Ar instead of Kr, and for a F₂ laser premix B may not be used. Thus, by injecting premix A and premix B into the tube via the valve assembly, the fluorine and krypton concentrations (for the KrF laser, e.g.) in the laser tube, respectively, can be replenished. A certain amount of gas can be released that corresponds to the amount that was injected. Additional gas lines and/or valves can be used to inject additional gas mixtures. New fills, partial and mini gas replacements, and gas injection procedures, such as enhanced and ordinary micro-halogen injections on the order of between 1 milliliter or less and 3-10 milliliters, and any and all other gas replenishment actions, can be initiated and controlled by the processor, which can control valve assemblies of the gas handling unit and the laser tube based on various input information in a feedback loop.

Exemplary line-narrowing optics contained in the rear optics module can include a beam expander, an optional interferometric device such as an etalon and a diffraction grating, which can produce a relatively high degree of dispersion, for a narrow band laser such as is used with a refractive or catadioptric optical lithography imaging system. As mentioned above, the front optics module can include line-narrowing optics as well.

For a semi-narrow band laser such as is used with an all-reflective imaging system, the grating can be replaced with a highly reflective mirror, and a lower degree of dispersion can be produced by a dispersive prism. A semi-narrow band laser would typically have an output beam linewidth in excess of 1 pm, and can be as high as 100 pm in some laser systems, depending on the characteristic broadband bandwidth of the laser.

The beam expander of the above exemplary line-narrowing optics of the rear optics module can include one or more prisms. The beam expander can include other beam expanding optics, such as a lens assembly or a converging/diverging lens pair. The grating or a highly reflective mirror can be rotatable so that the wavelengths reflected into the acceptance angle of the resonator can be selected or tuned. Alternatively, the grating, or other optic or optics, or the entire line-narrowing module, can be pressure tuned. The grating can be used both for dispersing the beam for achieving narrow bandwidths, as well as for retroreflecting the beam back toward the laser tube. Alternatively, a highly reflective mirror can be positioned after the grating, which can receive a reflection from the grating and reflect the beam back toward the grating in a Littman configuration. The grating can also be a transmission grating. One or more dispersive prisms can also be used, and more than one etalon can be used.

Depending on the type and extent of line-narrowing and/or selection and tuning that is desired, and the particular laser that the line-narrowing optics are to be installed into, there are many alternative optical configurations that can be used.

A front optics module can include an outcoupler for outcoupling the beam, such as a partially reflective resonator reflector. The beam can be otherwise outcoupled by an intra-resonator beam splitter or partially reflecting surface of another optical element, and the optics module could in this case include a highly reflective mirror. The optics control module can control the front and rear optics modules, such as by receiving and interpreting signals from the processor and initiating realignment or reconfiguration procedures.

Various embodiments relate particularly to excimer and molecular fluorine laser systems configured for adjustment of an average pulse energy of an output beam, using gas handling procedures of the gas mixture in the laser tube. The halogen and the rare gas concentrations can be maintained constant during laser operation by gas replenishment actions for replenishing the amount of halogen, rare gas, and buffer gas in the laser tube for KrF and ArF excimer lasers, and halogen and buffer gas for molecular fluorine lasers, such that these gases can be maintained in a same predetermined ratio as are in the laser tube following a new fill procedure. In addition, gas injection actions such as μHIs can be advantageously modified into micro gas replacement procedures, such that the increase in energy of the output laser beam can be compensated by reducing the total pressure. In contrast, or alternatively, conventional laser systems can reduce the input driving voltage so that the energy of the output beam is at the predetermined desired energy. In this way, the driving voltage is maintained within a small range around HVₒₚₜ, while the gas procedure operates to replenish the gases and maintain the average pulse energy or energy dose, such as by controlling an output rate of change of the gas mixture or a rate of gas flow through the laser tube.

Further stabilization by increasing the average pulse energy during laser operation can be advantageously performed by increasing the total pressure of gas mixture in the laser tube up to Pₘₐₓ. Advantageously, the gas procedures set forth herein permit the laser system to operate within a very small range around HVₒₚₜ, while still achieving average pulse energy control and gas replenishment, and increasing the gas mixture lifetime or time between new fills.

A laser system having a discharge chamber or laser tube with a same gas mixture, total gas pressure, constant distance between the electrodes and constant rise time of the charge on laser peaking capacitors of the pulser module, can also have a constant breakdown voltage. The operation of the laser can have an optimal driving voltage HVₒₚₜ, at which the generation of a laser beam has a maximum efficiency and discharge stability.

Variations on embodiments described herein can be substantially as effective. For instance, the energy of the laser beam can be continuously maintained within a tolerance range around the desired energy by adjusting the input driving voltage. The input driving voltage can then be monitored. When the input driving voltage is above or below the optimal driving voltage HVₒₚₜ by a predetermined or calculated amount, a total pressure addition or release, respectively, can be performed to adjust the input driving voltage a desired amount, such as closer to HVₒₚₜ, or otherwise within a tolerance range of the input driving voltage. The total pressure addition or release can be of a predetermined amount of a calculated amount, such as described above. In this case, the desired change in input driving voltage can be determined to correspond to a change in energy, which would then be compensated by the calculated or predetermined amount of gas addition or release, such that similar calculation formulas may be used as described herein.

It should be recognized that a number of variations of the above-identified embodiments will be obvious to one of ordinary skill in the art in view of the foregoing description. Accordingly, the invention is not to be limited by those specific embodiments and methods of the present invention shown and described herein. Rather, the scope of the invention is to be defined by the following claims and their equivalents.

What is claimed is:

1. A gas discharge laser system, comprising:
a resonator including therein a discharge chamber filled with a gas mixture, the discharge chamber containing a plurality of electrodes connected to a discharge circuit for energizing the gas mixture and generating an optical pulse in the discharge chamber, the resonator further including at least one window at an end of the discharge chamber for sealing the discharge chamber and for transmitting the optical pulse as an optical beam; and
an optics module positioned in a path of the optical pulse in the resonator, the optics module including therein a wavelength tuning element and a tuning motor coupled to the wavelength tuning element, the tuning motor capable of adjusting the wavelength tuning element in order to tune the wavelength of the optical beam transmitted from the resonator.

2. A gas discharge laser system according to claim 1, further comprising:
a control module operable to provide a drive signal to the tuning motor in order to adjust the orientation of the wavelength tuning element.

3. A gas discharge laser system according to claim 1, wherein: the wavelength tuning element is a prism.

4. A gas discharge laser system according to claim 1, further comprising:
a bearing assembly for mounting the wavelength tuning element, the bearing assembly allowing for a rotation of the tuning element upon operation of the tuning motor.

5. A gas discharge laser system according to claim 1, further comprising:
a lever coupled between the wavelength tuning element and the tuning motor, such that motion of the tuning motor moves the tuning element to tune the wavelength of the optical beam.

6. A gas discharge laser system according to claim 5, further comprising:
a coupling mechanism coupling the lever to the tuning motor.

7. A gas discharge laser system according to claim 6, wherein:
the coupling mechanism includes a ball held in position by one of a magnet and a spring.

8. A gas discharge laser system according to claim 1, wherein:
the tuning motor adjusts the wavelength tuning element in order to achieve a wavelength stability of less than 0.03 pm.

9. A gas discharge laser system according to claim 1, further comprising:
a beam splitter positioned in a path of the optical beam in order to redirect a portion of the optical beam.

10. A gas discharge laser system according to claim 9, further comprising:
a diagnostic module receiving the redirected portion of the optical beam, the diagnostic module adapted to determine a wavelength of the optical beam and generate a wavelength signal in response thereto; and
a control module adapted to receive the wavelength signal and drive the tuning motor to adjust the orientation of the wavelength tuning element in response to the wavelength signal.

11. A gas discharge laser system according to claim 1, further comprising:
at least one additional tuning motor coupled to the wavelength tuning element and adapted to adjust the orientation of the wavelength tuning element.

12. A gas discharge laser system according to claim 1, wherein:
the tuning motor is one of a plurality of tuning flexibly coupled to the wavelength tuning element, the plurality of tuning motors being in a radial configuration about a drive cylinder, the drive cylinder being coupled to the wavelength tuning element.

13. A gas discharge laser system according to claim 1, wherein:
the tuning motor is flexibly coupled to the wavelength tuning element through a moveable gib connected to the tuning motor.

14. A gas discharge laser system according to claim 1, wherein:
the tuning motor is selected from the group consisting of piezo ceramic motors, linear drive motors, piezo drive motors, linear voice coil actuator drive units, and rotary voice coil actuator drive units.

15. An optics module for a gas discharge laser, the optics module comprising:
an optical module housing including at least one window for receiving and transmitting an optical beam;
a wavelength tuning element in the optical module housing positioned in a beam path of the optical beam;
a bearing assembly mounted inside the optical module housing and coupled to the wavelength tuning element, the bearing assembly allowing for a movement of the wavelength tuning element; and
a tuning motor mounted inside the optical module housing and coupled to the wavelength tuning element, the tuning motor capable of moving the wavelength tuning element in order to tune the wavelength of the optical beam transmitted from the optical module housing.

16. An optics module according to claim 15, further comprising:
a control module in communication with the tuning motor and capable of providing a drive signal to the tuning motor in order to cause a rotation of the wavelength tuning element.

17. An optics module according to claim 15, wherein:
the wavelength tuning element is a prism.

18. An optics module according to claim 15, wherein:
the tuning motor is selected from the group consisting of piezo ceramic motors, linear drive motors, piezo drive motors, linear voice coil actuator drive units, and rotary voice coil actuator drive units.

19. An optics module according to claim 15, further comprising:
a lever coupled between the wavelength tuning element and the tuning motor, the lever allowing for a rotation of the tuning element upon operation of the tuning motor.

20. An optics module according to claim 15, wherein:
the tuning motor rotates the wavelength tuning element in order to achieve a wavelength stability of the optical beam of less than 0.03 pm.

21. A method for fast tuning of a gas discharge laser, comprising:
monitoring the wavelength of an output beam of the gas discharge laser; and
driving a tuning motor in an optical module of the gas discharge laser in response to the monitored wavelength, the tuning motor being coupled to a wavelength tuning element in a beam path of the output beam such that operation of the tuning motor functions to rotate the wavelength tuning element in order to tune the wavelength of the optical beam.

22. A method according to claim 21, further comprising:
redirecting a portion of the output beam to a diagnostic module capable of monitoring the wavelength of the output beam and generating a wavelength signal in response thereto.

23. A method according to claim 22, further comprising:
receiving the wavelength signal to a control module capable of determining a necessary amount to operate the tuning motor in order to properly adjust the orientation of the wavelength tuning element in order to tune the wavelength of the optical beam.

24. A method according to claim 21, further comprising:
maintaining a wavelength stability of the output beam of less than 0.03 pm.
